(19) United States
(12) Patent Application Publication
(10) Pub. No.: US 2016/0168843 A1
(43) Pub. Date: Jun. 16, 2016

(54) STORAGE UNIT

(71) Applicant: Norman Brett BELL, Mt Barker, Western Australia (AU)

(72) Inventor: Norman Brett Bell, Mt. Barker, Western Australia (AU)

(21) Appl. No.: 14/909,112

(22) PCT Filed: Jul. 31, 2014
(86) PCT No.: PCT/AU2014/000774

§ 371 Date: Jan. 30, 2016

(30) Foreign Application Priority Data
Jul. 31, 2013 (AU) 2013902854

(51) Int. Cl. E04B 1/344; E04H 1/12; B60P 3/07

(52) U.S. Cl. CPC E04B 1/344; B60P 3/07; E04H 1/1205

(57) ABSTRACT

A storage unit comprising a cover adapted to be mounted on a support surface wherein the cover is pivotally attached to the support surface to allow selective displacement of the cover between a tilted condition and an un-tilted condition. wherein the cover comprises a front end, a rear end and two sides, wherein the front end is pivotally attached to the support surface. The invention also provides for a cover adapted to be mounted on a support surface wherein the cover is pivotally attached to the support surface to allow selective displacement of the cover between a tilted condition and an un-tilted condition, wherein the cover comprises a rear end and a slanted truncated front end, wherein a lower portion of the slanted truncated front end is pivotally attached to the support surface, and a method for storing at least one good within the storage unit

### TECHNICAL FIELD

The present invention relates to storage units

The invention has been devised particularly, although not necessarily solely, in relation to storage units for motorbikes.

### BACKGROUND ART

The following discussion of the background art is intended to facilitate an understanding of the present invention only. The discussion is not an acknowledgement or admission that any of the material referred to is or was part of the common general knowledge as at the priority date of the application.

Storage and transportation of goods such as motorbikes is typically a cumbersome procedure. This is because motorbikes are relatively unstable and thus easily tipped over. Therefore, motorbikes or any relatively unstable good need to be fastened properly when mounted on a trailer or stored in storage units such as, for example, a shipping container.

Further, it is preferred that storage units for motorbikes may be of reduced size. However, storing a motorbike in a storage unit of reduced size typically is cumbersome procedure. This is because it is necessary to enter the storage unit in conjunction with the bike to maintain the motorbike in upright position as the bike is pushed into the storage unit. This can be a difficult procedure in particular if relatively heavy and large motorbikes are stored in the storage unit. Also, to secure the motorbikes in a reduced space is typically a cumbersome process. Thus, there exists the risk that motorbikes may not be secured properly within the storage units. Therefore, the storage units for motorbikes have typically a relatively large volume to allow the rider to push the bike into the storage unit as well as properly secure the motorbike within the storage unit.

Moreover, in parking lots motorbikes are typically parked on parking bays which do not exclude third parties from accessing the motorbikes. Also, these parking bays do not protect the motorbikes from the weather. Thus, for example, motorbikes may be subject to strong winds and snow storms. The motorbikes can be tipped over by these strong winds. This typically can damage the motorbikes. Further, the low temperature of snow storms may damage the engine of the motorbikes or temporally shut down the operation of the engines of the motorbikes.

It is against this background that the present invention has been developed.

### SUMMARY OF INVENTION

According to a first aspect of the invention there is provided a storage unit comprising a cover adapted to be mounted on a support surface wherein the cover is pivotally attached to the support surface to allow selective displacement of the cover between a tilted condition and an un-tilted condition.

Preferably, the cover comprises a front end, a rear end and two sides, wherein the front end is pivotally attached to the support surface. In this arrangement, the interior of the storage unit is accessible through any of the sides of the storage unit when the cover is in the tilted condition.

In one arrangement, the front end of the cover comprises a slanted truncated front end having a lower front portion pivotally attached to the surface.

Preferably, the rear end of the cover is an open end to allow access to the interior of the storage unit.

Preferably, the cover comprises a door for opening and closing of the storage unit.

Preferably, the door is pivotally attached to a lower portion of the end of the cover to allow selective displacement of the door between an open condition and a closed condition.

Preferably, the support surface comprises a parking bay of a parking lot.

Preferably, the cover is adapted to be moved.

Preferably, the cover comprises a plurality of swivel castors.

Preferably, the swivel castors are lockable.

Preferably, the cover further comprises a canopy and a support frame adapted to be mounted on the support surface, the support frame being adapted to receive the canopy, wherein the cover is pivotally attached to the support frame to allow selective displacement of the cover between a tilted condition and an un-tilted condition.

Preferably, the storage unit comprises at least one gas strut having an end attached to the support surface and the other attached to the cover.

Preferably, the support frame comprises an upper surface for receiving the canopy and a lower surface adapted to receive the plurality of swivel castors.

Preferably, the door is pivotally attached to a lower portion of the end of the cover to allow selective displacement of the door between an open condition and a closed condition wherein the door when in the open condition defines a ramp to facilitate access into the storage unit.

In an alternative arrangement, the door is pivotally to a side wall of the cover to allow pivotal movement of the door around the vertical axis of the cover.

Preferably, there are a plurality of doors.

Preferably, the support structure comprises a floor adapted to receive at least one good to be stored in the storage unit.

Preferably, the storage unit comprise means for fastening the at least one good within the storage unit.

Preferably, the at least one good comprises at least one motorbike.

Preferably, the support structure comprises a trailer supported on wheels to allow transportation of the storage unit.

Preferably, the trailer comprises means for supporting the trailer in a substantial horizontal position.

Preferably, the storage unit further comprises solar panels to generate electrical energy.

Preferably, the storage unit is adapted to charge rechargeable batteries within the cover.

Preferably, the cover comprises ventilation means to impede condensation build up in the cover and allow discharge of gas generated within the cover.

Preferably, the storage unit further comprises means for storing goods within the cover.

Preferably, the means for storing goods comprises hooks and/or shelving attached to the inner walls of the cover.

Preferably, the storage unit further comprises lights powered by the electricity generated by the solar panels.

According to a second aspect of the invention there is provided a cover adapted to be mounted on a support surface wherein the cover is pivotally attached to the support surface to allow selective displacement of the cover between a tilted condition and an un-tilted condition wherein the cover comprises a rear end and a slanted truncated front end, wherein a lower portion of the slanted truncated front end is pivotally attached to the support surface.

According to a third aspect of the invention there is provided a storage unit comprising a cover adapted to be mounted on a support surface for defining a storage area having a volume, wherein the cover is adapted to selectively increase or decrease the volume of the storage area.

Preferably, the storage unit provides a storage area which is marginally larger than the volume occupied by the good or goods to be stored in the storage unit.

By increasing the volume of the storage area, inserting of the goods into the storage area and securing the goods therein is facilitated. This is because of the fact that the increased volume provides an additional space for manipulating of the goods during inserting and securing of the goods within the storage unit. After insertion and securing of the goods in the storage unit the volume of the storage area may be decreased. In this manner, it is possible to provide the storage unit with a storage area which is marginally larger than the volume occupied by the good or goods to be stored in the storage unit.

Preferably, the cover is pivotally attached to the support surface to allow selective displacement of the cover between a tilted condition and an un-tilted condition to allow selectively increasing or decreasing the volume of the storage area.

According to a fourth aspect of the invention there is provided a method for storing at least one good within a storage unit comprising a storage area having a first volume, wherein the method comprises:
increasing the first volume to a second volume of the storage area prior inserting of the at least one good within the storage area;
inserting the at least one good within the storage area; and
reducing the second volume to the first volume after insertion of the at least one good.

Preferably, the first volume is marginally larger than the at least one good.

Preferably, the storage unit comprises a cover and a support surface adapted to receive the cover defining the storage area between the surface and the un-tilted cover, wherein the step of increasing the first volume to a second volume of the storage area comprises tilting the cover to a tilted condition and the step of reducing the second volume to the first volume comprises returning the cover to the un-tilted condition.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a perspective view of a storage unit in accordance with a first embodiment of the invention in the closed condition.

FIG. 2 is a rear top perspective view of the storage unit shown in FIG. 1;

FIG. 3 is side view of the storage unit shown in FIG. 1 in the open condition;

FIG. 4 is a rear top perspective view of the storage unit shown in FIG. 1 in the open condition;

FIG. 5 is a rear view of the storage unit shown in FIG. 1 in the open condition;

FIG. 6 is a side view of the storage unit shown in FIG. 1 in the open condition in use;

FIG. 7 is a top view of a first arrangement of a storage unit in accordance with a second embodiment of the invention;

FIG. 8 is a side view of the storage unit shown in FIG. 7 showing the process of opening of the storage unit;

FIG. 9 is a front view of the storage unit shown in FIG. 7;

FIG. 10 is a rear perspective of a second arrangement of a storage unit in accordance with the second embodiment of the invention;

FIG. 11 is a side view of the storage unit shown in FIG. 10;

FIG. 12 is a rear view of the storage unit shown in FIG. 10;

FIG. 13 is a rear perspective of a third arrangement of a storage unit in accordance with the second embodiment of the invention;

FIG. 14 is a side view of an alternative arrangement of the storage unit shown in FIG. 10; and

FIG. 15 is a bottom view of the storage unit shown in FIG. 14.

### DESCRIPTION OF EMBODIMENTS

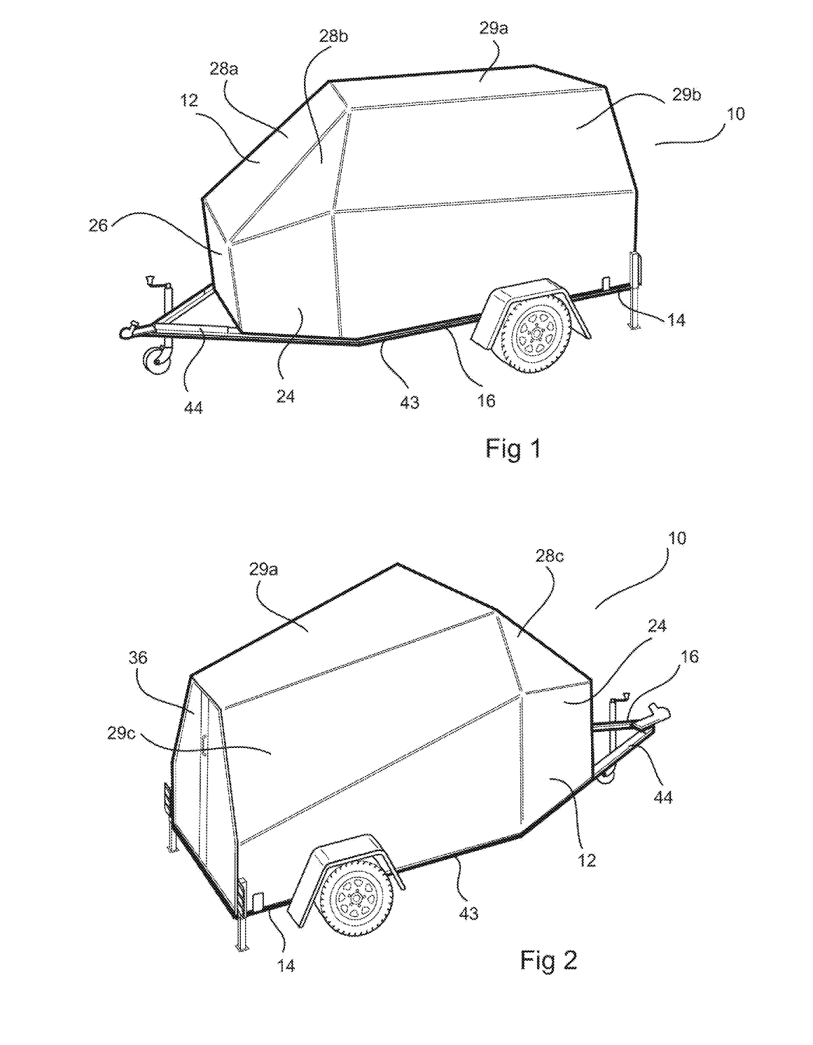

FIGS. 1 to 6 show a particular arrangement of a storage unit 10 in accordance with a first embodiment of the invention. The storage unit 10 shown in FIGS. 1 to 6 comprise a cover 12 and a support structure 14. The cover 12 is mounted on the support structure 14. In this manner, a space is defined within the storage unit 10 having a volume to allow storage of goods. In particular arrangements the volume is such that it is marginally larger the volume occupied by the good(s) to be stored in the storage unit 10.

The cover 12 is pivotally fastened to the support structure 14. This allows to selectively displacing the cover 12 between a tilted condition and an un-tilted condition.

The particular arrangement of the storage unit 10 shown in FIGS. 1 to 6 comprises a mobile lower support structure 14 such as a trailer 16. This particular arrangement allows storage as well as transportation of, for example a motorbike.

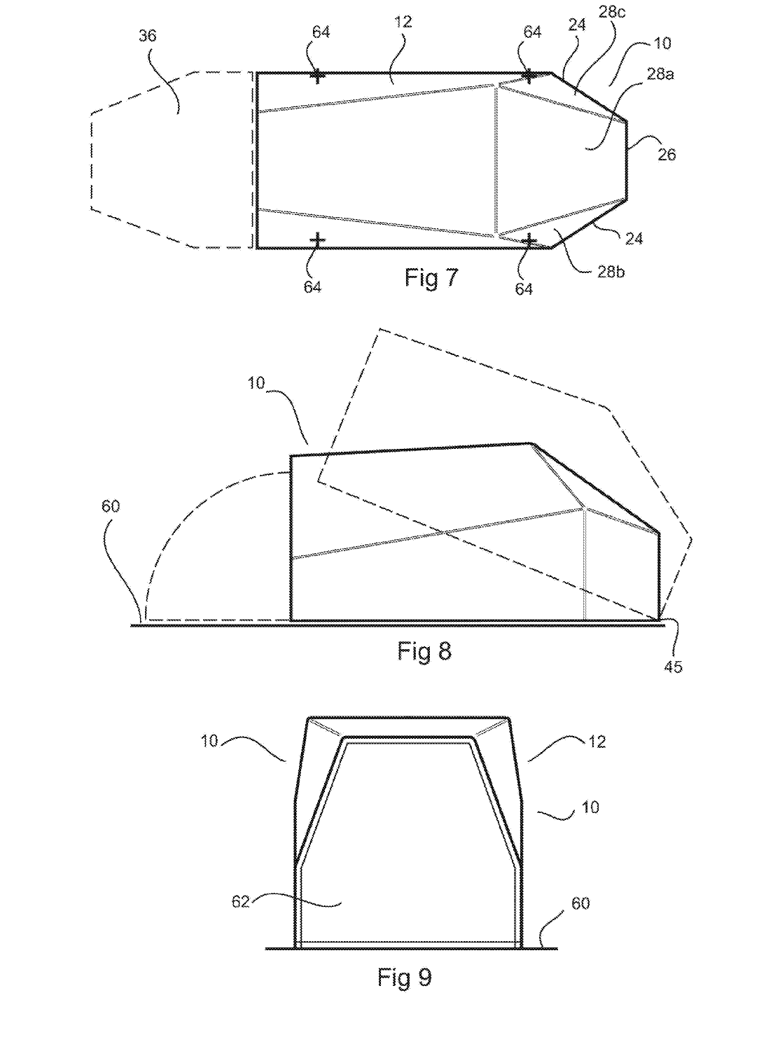

FIGS. 7 to 9 show a particular arrangement of a storage unit 10 in accordance with a second embodiment of the invention. This particular arrangement comprises an upper cover 12 supported on a support surface such as a ground. In this manner, a space is defined within the storage unit 10, the space having a volume of a particular magnitude. In particular arrangements, the volume is such that it is marginally larger than the volume occupied by the good(s) to be stored in the storage unit 10.

The cover 12 is pivotally fastened to the ground to allow selective displacement of the cover 12 between a tilted condition and an un-tilted condition. This particular arrangement is adapted for storing, for example, motorbikes in parking lots. This arrangement of storage unit 10 is particularly useful for protecting the motorbikes stored within the unit 10 from the weather as well as access by third parties and non-authorised use of the motorbikes is impeded when parking of the motorbike in the parking lots.

As will be described with reference to the method of operation of the storage units 10 in accordance with the present embodiments of the invention, the storage units 10 facilitate securing of the goods to be stored in the storage units 10. This is because the storage units 10 in accordance with the present embodiments of the invention are adapted to increase their volume to facilitate storing of the goods within the storage unit 10. Also, the storage units 10 in accordance with the present embodiments of the invention are adapted to facilitate access to the goods when stored in the storage units 10. Particular arrangements the storage units 10 are adapted to provide access, to personnel located adjacent and outside the storage unit, to the interior of the storage unit at locations around the periphery of the storage unit; in particular, the storage unit 10 is adapted to provide access to the interior of the storage unit 10 through the sides of the storage unit 10.

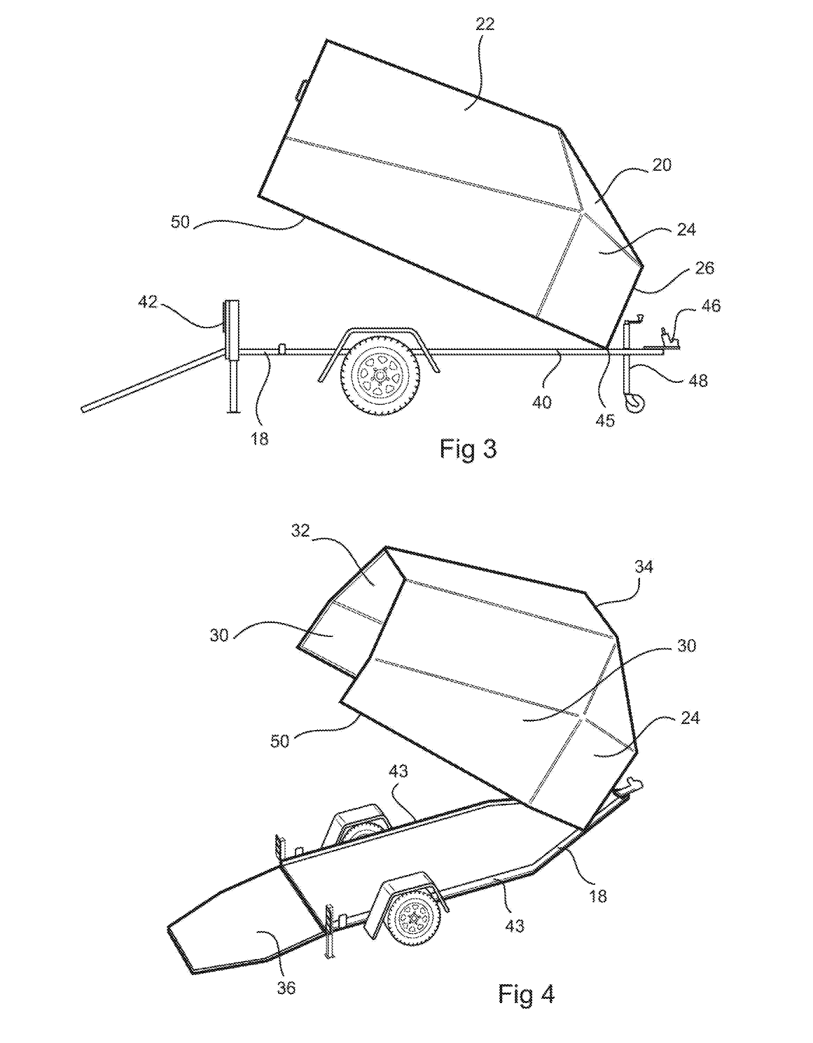

Referring now to FIGS. 3 and 4, as mentioned above, the storage unit 10 in accordance with the first embodiment of the invention comprises the cover 12 mounted on the trailer 16.

The trailer 16 comprises a chassis 18 having a front 40 and a rear 42 and two sides 43. The chassis 18 is supported from a pair of wheels. The trailer 16 comprises the support surface 14 which is defined by the chassis 18. The support surface 14 is configured to receive the cover 12.

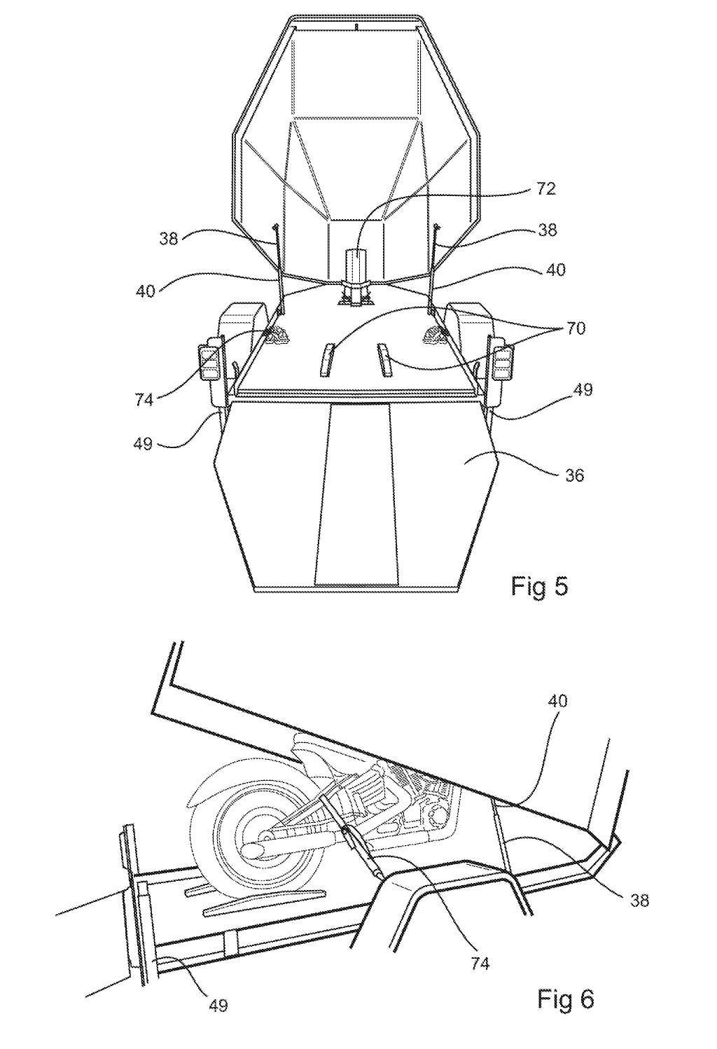

A triangular frame 44 is attached to the front 40 of the trailer 16. The triangular frame 14 defines the draw bar of the trailer 16. The triangular frame 44 comprises a coupling adapted to be coupled to the tow hitch of a towing vehicle (not shown). A jockey wheel 48 is attached to the triangular frame 44 to support the trailer when required. In addition, as shown in FIGS. 5 and 6, a plurality of support legs 49 are retractably supported from the rear 42 of the trailer 16 to support the trailer 16 when the legs 49 are in extended condition. As will be described with reference to the method of operation of the trailer, the support legs 49 allow utilising the trailer 18 as a storage unit for goods—for example, motorbikes.

In the particular arrangement shown in FIGS. 1 to 7, the trailer 18 comprises a ramp 36. The ramp 36 is pivotally attached to the rear 42 of the trailer 16. As will be described with reference to the method of operation of the storage unit 10, the ramp 26 facilitates moving the goods into and out of the storage unit 10 as well as selectively closing and opening of the storage unit 10.

The cover 12 comprises a front portion 20 and a rear portion 22. The front portion 20 of the particular arrangement shown in FIGS. 1 to 7 is defined by two side walls 24, a front wall 26 and slanted roofs 28a to 28c. Each side wall 24 is attached to a side of the front wall 26. The side walls 24 are attached at an angle with respect to the front wall 26 defining an inner space with a surface area configured as a trapezoid (see FIG. 7). This inner space is covered by an arrangement of the three slanted roofs 28 defining a slanted front end 20 (see FIGS. 1 and 2). The height of the front end 20 decreases towards the front of the cover 12. Further, the front end 20 is a truncated frond end 20 due to the front wall 26 being arranged perpendicularly to the sides walls 24 of the cover 12. In this manner, the front end 20 is a slanted truncated front end 20. It is particularly useful that the front end is a slanted truncated front end 20 as defined above. This is because it reduces the volume that the front end may occupy. Thus, this particular shape of front end 20 can be advantageous for placing the storage unit adjacent to walls of under ground parking. This is because typically underground parking may include piping and air ducts hanging from the roofs of the underground parking at locations adjacent to the walls of the underground parking. The slanted truncated front end 20 of the cover 12 permits abutting the front wall 26 to the wall of the underground parking. This is because the height of the front end 20 reduces towards the front of the cover 12.

The rear section 22 comprises two side walls 30. The side walls 30 are arranged opposite to each other defining a space between them. The space is covered by an arrangement of slanted top walls 29. The rear portion 22 comprises a front end 34 and a rear end 32. The side walls 30 in conjunction with the sides 43 of the trailer 16 define the sides of the storage unit 10.

The above described arrangement of walls 24, 26, 29 and 30 defines the cover 12 in such a manner that the storage unit 10 provides a volume which is marginally larger than the goods (for example, the motorbike) to be stored within the storage unit 10.

As shown in FIG. 4, the rear end 32 is an open end adapted to allow entrance and exit of the goods to be stored in the storage unit 10. The ramp 36 is adapted to close the rear end 32. As mentioned above, the ramp 36 is pivotally attached to the rear end of the trailer 14 for selectively closing and opening of the storage unit 10.

The cover 12 is adapted to be mounted on the trailer 14. In particular, the cover 12 comprises a lower rim 50 (defined by the lower edges of the walls 24, 26 and 30). In particular, the lower rim 50 is adapted to be abutted onto the periphery of the support structure 14 of the trailer 16. In particular arrangements, the support structure 14 is adapted to receive the rim 50 in such a manner that a seal is defined between the rim 50 and the periphery of the support structure 14. The seal impedes entrance of water and debris into the storage unit 10.

As mentioned before, in accordance with particular arrangements of the present embodiments the cover 12 is pivotally attached to the support structure. This allows selectively displacing the cover 12 between a tilted condition and an un-tilted condition. By tilting the cover 12, the volume of the storage unit 10 may be increased. As will be described with reference to the method of operation of the storage unit 10, increasing the volume facilities inserting the good (for example, the motorbike) within the storage unit 10.

In the particular arrangement shown in FIGS. 1 to 6, the front section 24 of the cover 12 is pivotally attached to the front 40 of the trailer 18 (see FIGS. 3 and 4). As shown in FIG. 3, the slanted truncated front end 20 is attached to the front 40 of the trailer 18. In particular, the lower portion 45 of the front wall 26 is attached to the trailer 18.

The fact that the cover 12 is pivotally attached to the front section of the trailer is particular advantageous because it allows tilting the cover 12 (see FIG. 3). Tilting the cover 12 allows as mentioned above increasing the volume of the storage unit 10. Also, tilting the cover allows separating the rim 50 of the cover 12 from the support structure 14 of the trailer 16. In particular, by tilting the cover 12 a clearance is formed between the rim 50 of the cover 12 and the support structure 14 of the trailer 16. This is particular advantageous because by tilting the cover 12 access is provided to the interior of the storage unit 10 through the sides of the storage unit 10. This facilitates fastening or unfastening of the goods (stored in the storage unit 10) within the storage unit 10. This is can be seen in greater detail in FIGS. 5 and 6.

FIGS. 5 and 6 show the storage unit 10 in accordance with the first embodiment of invention. FIG. 5 is a rear view of an open storage unit 10 having the cover 12 located in the tilted condition. FIG. 6 shows a side view of the storage unit shown in FIG. 5, with a motorbike stored and fastened within the storage unit 10. As can be appreciated from the FIGS. 5 and 6, the fact that the cover 12 is adapted to be located in the tilted condition is particularly advantageous because (1) the inner volume of the cover 12 is increased and (2) it allows access to the interior of the storage unit 10 through the sides of the storage unit 10.

FIGS. 5 and 6 show the cover 12 located in the tilted condition. In this arrangement, the cover 12 is secured in the tilted condition to hinder the cover 12 from returning to the un-tilted condition. The cover 12 is secured in the tilted condition via fastening means 38. In the arrangement shown in FIGS. 5 and 6, the fastening means 38 comprises extended bars 40 extending from the support structure 14 of the trailer 18 to the cover 12. In a particular arrangement, the bars 40 may be adapted to be selectively displaced between a contracted condition and an extended condition so as to secure the cover 12 in the tilted condition. However, in alternative arrangements, the cover 12 may be secured at a plurality of locations or the cover 12 may be secured at any location between the tilted and un-tilted condition. This is particularly advantageous because it allows tilting the cover 12 and secure the tilted cover 12 at any location between the tilted and non-tilted condition. As will be described with reference to the method of operation of the storage unit 10, this is particularly useful for tightening the tie-downs which secure the motorbike within the storage unit 10 during transportation of the motorbike.

We refer now to the second embodiment of the invention. The storage unit 10 according to the second embodiment is similar to the storage unit 10 according to the first embodiment and similar reference numerals are used to identify similar parts.

FIGS. 7 to 9 show a particular arrangement of the storage unit 10 in accordance with the second embodiment of the invention. The storage unit 10 in accordance with the second embodiment of the invention comprises a cover 12 as the cover 12 described in relation to the first embodiment of the invention. The cover 12 is adapted to be mounted on a support surface 60. The support surface 60 may, for example, be the ground of a parking bay in a parking lot. Alternatively, the support surface 60 may be a surface of any means of transportation such as, for example, trucks, planes or ships. As will be described with reference to the method of operation of the storage unit 10, this embodiment allows providing a storage place for goods, such as motorbikes which impedes third parties from accessing the motorbikes as well as conceals the goods stored inside the storage unit 10 from the weather.

In an arrangement, the cover 12 may include a canopy and a base frame made of aluminium angle on which the canopy is mounted. As will be described at a later stage, the base frame may incorporate lockable swivel castor 86 to facilitate transport of the storage unit 12 if the location of the storage unit 10 needs to be changed.

The storage unit 10 in accordance with the second embodiment of the invention is pivotally attached to the support surface 60. As shown in FIG. 8, the front portion 20 of the cover 12 is pivotally attached to the support surface 60. In particular, the lower portion 45 of the front wall 26 is pivotally attached to the support surface 60. As mentioned in relation to the first embodiment, this allows selectively moving the cover between a tilted and an un-tilted condition.

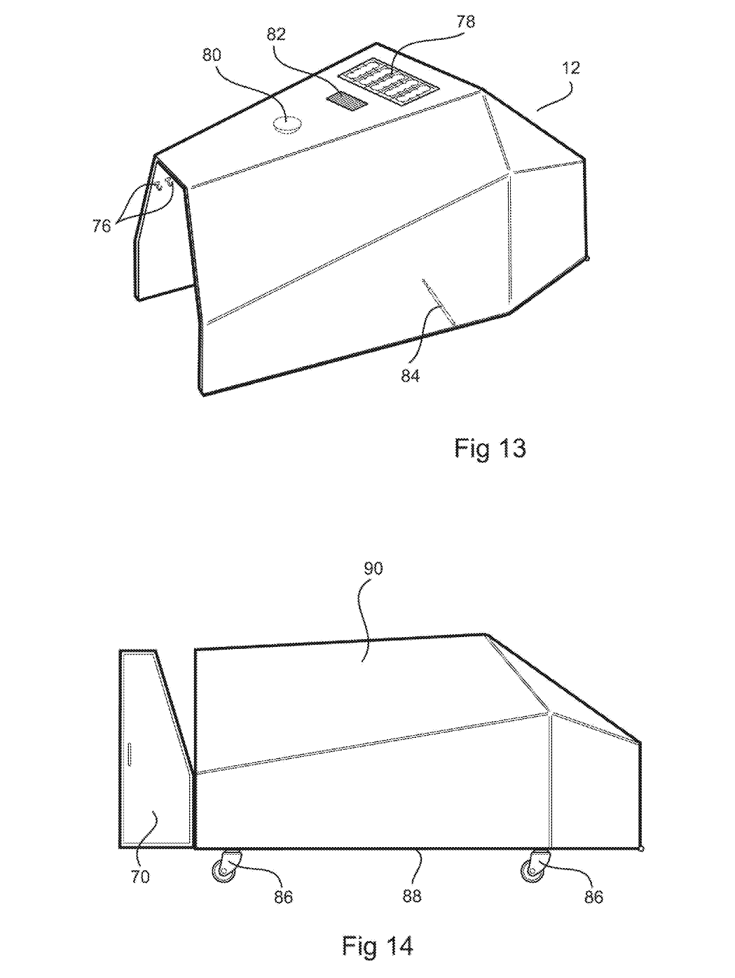

Further, the storage unit 10 may be opened and closed. For this, the storage unit comprises a door 62. The door 62 is pivotally attached to the rear portion of the cover 12. This allows opening and closing of the storage unit 10 (see FIG. 8). As shown in FIG. 13, the cover 12 may be elevated with the assistance of gas struts 84.

The cover 12 is secured to the support surface 60 via anchors 64. In an arrangement, the anchors 64 are attached to the rim 50 of the cover 12. The cover 12 is fastened by securing the anchors 64 to the support surface 60.

Moreover, the storage unit 10 may comprise fastening means (such as tie-downs) to secure, for example, the motorbike within the storage unit 10. In a particular arrangement, the tie-downs may be secured to the inside surface of the cover 12. Alternatively, the tie-downs may be fastened to the support surface 60.

The previously described first arrangement of the storage unit 10 in accordance with the second embodiment of the invention comprises a cover 12 which is directly attached to the support surface 60. In this particular arrangement, the motorbike or any of the goods stored in the storage unit 10 is supported on the support surface 60. In an alternative arrangement, the storage unit 10 may incorporate a support structure 14 onto which the goods stored in the storage unit 10 may be supported. In this particular arrangement, the support structure 14 is adapted to receive the rim 50 of the cover 12 and provides the surface for supporting the goods to be stored in the storage area 10. In this manner, an enclosed area is defined by the cover 12 and the support structure 14. In this particular arrangement, the cover 12 is pivotally attached to the support structure 14 which as mentioned before allows selectively displacing the cover 12 between a tilted condition and an un-tilted condition. Further, in this arrangement, the door 62 may be pivotally attached to the support structure 14. This particular arrangement is particularly useful because it provides a storage unit 10 which may be, for example, releasably fastened to a support surface 60 such as the ground of a parking lot. The storage unit 10 including the good may then be released from the support surface 60 for transportation of the storage unit 10—including the good—to another location or to be mounted on a means for transportation such as a vehicle, plane or ship. This is possible because of the fact that the storage unit 10 in accordance with this second arrangement comprises the cover 12 as well as the support structure 14 which provides the surface for supporting the good to be stored in the storage unit 10. In this manner the second arrangement defines a container adapted to store and transport a good, such as a motorbike. In contrast, in the first arrangement of the second embodiment the storage unit 10 comprises the cover 12 which is adapted to be fastened to a support surface 60 such as the ground of a parking lot. In this first arrangement, the goods to be stored in the storage area 10 rests on the ground of, for example, a parking lot.

As mentioned before, the storage unit 10 in accordance to the present embodiments of the invention is particularly useful for storing goods such as motorbikes. This is particularly true because the storage unit 10 provides access to the interior of the storage unit trough the sides of the storage unit 10. This facilitates fastening of the motorbikes after the motorbikes have been moved into the storage area.

Moreover, the storage unit 10 is adapted to increase the volume of the storage unit 10 for storing the good(s). After storing of the goods, the volume is reduced. The volume increase and reduction is accomplished in the present embodiments by the fact that the cover 12 may be selectively displaced form a tilted condition to an un-tilted condition. As will be described in the next paragraph, the fact that the volume of the storage unit may be increased prior incorporation of the good(s) is particularly useful because it facilitates storing of the good(s) into the storage area. In particular, it facilitates the entrance of a bike rider in the storage unit 10 with the motorbike and to fasten the motorbike inside the storage area 10.

The following description of the method of use of the storage unit 10 is limited to the storage unit 10 in accordance with the first embodiment of the invention. However, these descriptions apply as well to the arrangements of the second embodiment of the invention.

In operation, for storing of a motorbike in the storage unit 10, the unit 10 is opened by pivoting the ramp 36 from the closed condition to the open condition. Further, the cover 12 is then tilted to locate the cover 12 at a tilted condition (see FIG. 5). At this stage, the motorbike may be pushed or ridden onto the ramp 36 and into the storage unit 10. The fact that the cover 12 may be tilted allows increasing the volume provided by the storage unit 10 prior introducing, for example, the motorbike within the storage unit 10. This is particularly useful because it allows the motorbike rider to walk upright into the storage unit 10 while pushing the motorbike into the storage unit 10. In accordance with particular arrangements, the storage unit 10 may be designed such that a motorbike rider may ride the bike into the storage unit 10 when the cover 12 is in the tilted condition and, thus, the volume of the storage unit 10 is increased.

Once the motorbike is located inside the storage unit 10, the motorbike may be tied down to secure the motorbike within the storage unit 10 (see FIG. 6). After tying down the motorbike, the cover 12 may be returned to the un-tilted condition and the ramp 36 may be pivoted back into the closed condition. At this stage, the storage unit 10 may be engaged to a vehicle for transportation of the motorbike to a particular location.

The storage unit 10 in accordance with the first embodiment may also be used as a storage space. For this, the support legs 49 may be located in the extended condition so as to stabilise the storage unit 10 in the horizontal condition. In this manner the storage unit 10 in accordance with the first embodiment provides a trailer for transporting goods as well as an enclosed storage area to provide shelter to the goods stored therein.

Further, it was mentioned before that the cover 12 may be located in a plurality of tilted positions. This is particularly useful because it allows tilting the cover 12 at specific positions in according to particular actions that need to be taken. For example, the cover 12 may be tilted only slightly in order to tighten the tie downs which secure the motorbike within the storage unit 10. Moreover, in some instances, it will be necessary to retighten the tie-downs. For example, during transportation of the motorbike the tie-downs may loosen and thus there is the need to be retightened them to avoid undesired movement of the motorbike within the storage unit 10 during transportation thereof. This can be accomplished by only slightly tilting the cover 12 so that access to the interior of the storage unit 10 is provided through the sides of the storage unit 10. Thus, there is no need to open the storage unit 10 so that a person enters the storage unit 10 for tightening of the tie-downs.

Moreover, the tilting of the cover 12 as well as the opening of the storage unit 10 by pivoting the ramp 36 or door 62 from the closed condition to the open condition may be remotely controlled. This allows tilting of the cover 12 and opening of the storage unit 10 when the motorbike rider is approaching the storage unit 10. This feature is particular useful for the arrangements of the second embodiment of the invention. As mentioned before, these arrangements provide enclosed parking areas for motorbikes at parking lots. The fact that the storage unit may be operated remotely allows a motorbike rider to tilt the cover 12 and open the door 62 prior approaching the storage unit 10. Once the cover 12 is titled and the storage unit 10 is open the rider mounted on the bike may ride into the storage unit 10. Once the motorbike rider has entered the storage unit 10, the rider may step down from the motorbike, secure the motorbike and after exiting the storage unit 10, the rider may remotely close the storage unit 10 by remotely moving the door 62 into the closed condition and returning the cover 12 to the un-tilted condition.

Referring to FIG. 5, in particular arrangements of the storage unit in accordance with the present embodiments of the invention, there may be included means for maintaining the motorbike in the upright condition. As shown in FIG. 5, the storage unit 10 may comprise a rear wheel stand 70 and a front wheel stand 72. These stands maintain the motorbike in the upright condition. Further, tie-downs 74 are included inside the storage unit 10 to secure the motorbike within the storage unit 10.

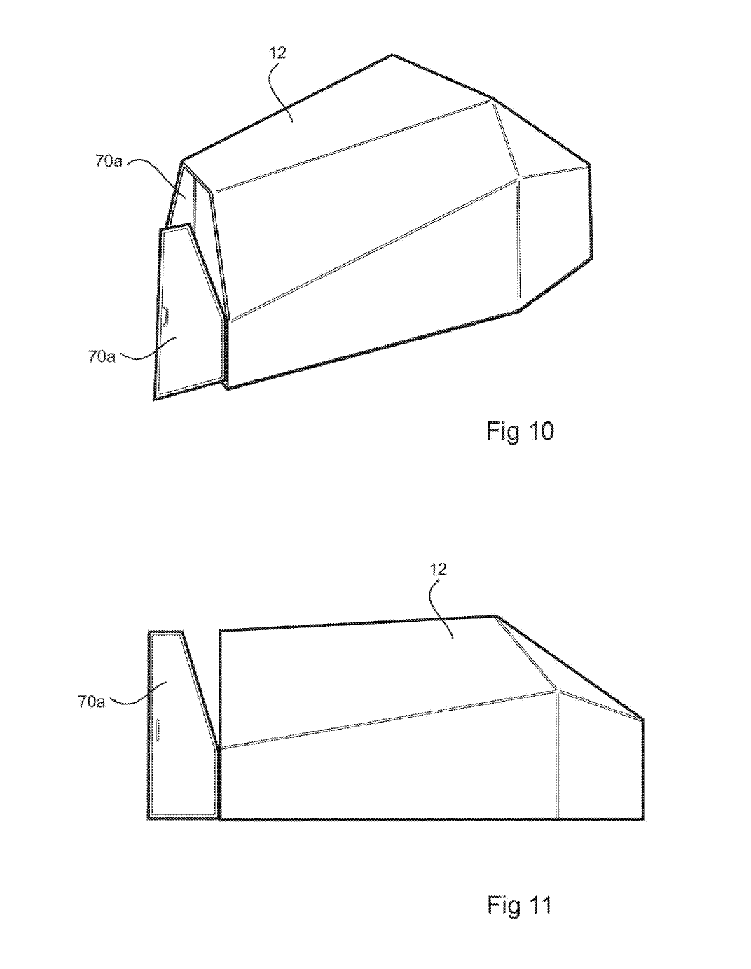

We refer now to FIGS. 10 to 12. These figures depict a second arrangement of the second embodiment of the invention. The second arrangement depicted in FIGS. 10 to 12 differ from the first arrangement in the manner in which the storage unit 10 is either closed or opened. The first arrangement of the second embodiment of the invention includes a door 62 that permits closing of the storage unit 10 by pivoting the door 62 in the vertical position. For opening of the storage unit 10, the door 62 is pivoted from the vertical position to the horizontal positon.

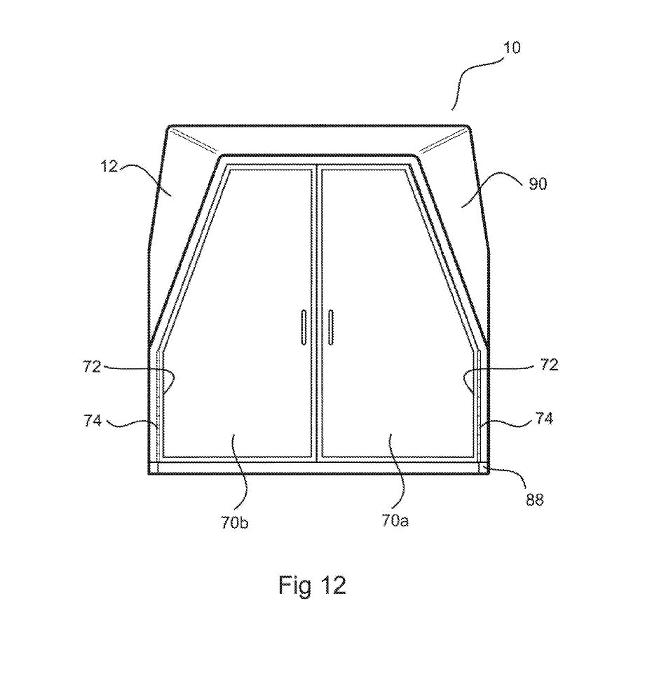

The second arrangement of the second embodiment of the invention comprises a pair of doors 70a and 70b that are hingedly attached to the rear portion of the cover 12 in such a manner that the doors 70 pivot around the vertical axis of the cover 12. As shown in FIG. 12, lower portions 72 of each door are pivotally arttached to the lower portions of the sides of the cover 12 via hinges 74. This allows selectively moving the doors between a closed and open condition by pivoting the doors 72 around the vertical axis of the cover 12. There may be provided vertical posts to secure the hinges 74 to the cover 12. In this second arrangement, the cover 12 may not necessarily be adapted to be selectively displaced between a tilted and un-tilted condition.

We refer now to FIG. 13. FIG. 13 shows an alternative arrangement of the covers 12 in accordance with the first and second embodiment of the invention.

The cover 12 depicted in FIG. 13 includes accessories such as hooks 76 attached to the inner side walls of the cover 12. The hooks 76 allow hanging bike clothing and helmets to be stored together with the bike within the storage unit 10. Shelving may also be attached to the inner walls of the cover 12.

Furthermore, the cover 12 comprises solar panels 76 located on the upper surface of the cover 12. It is particularly useful that the cover is provided with solar panels 78. The solar panels 78 may provide electric energy for charging the batteries of electrical bicycles or scoters stored within the storage unit 10. The electrical energy may also be used for powering of a light 80 located within the storage unit 10.

The cover 12 may also include ventilation means 82. The ventilation means reduce condensation build up within the storage area 10 and allow venting of any gases that may be produced during the charging of the batteries of the bikes.

The cover depicted in FIG. 13 also includes one or more gas struts 84 to assist during tilting of the cover 12 for opening of the storage unit. The gas struts are to be included in the arrangement of storage unit 10 that have their front pivotally attached to the trailer or support surface as shown in FIGS. 1 to 9. The gas struts 84 may also be adapted to keep the cover in tilted condition.

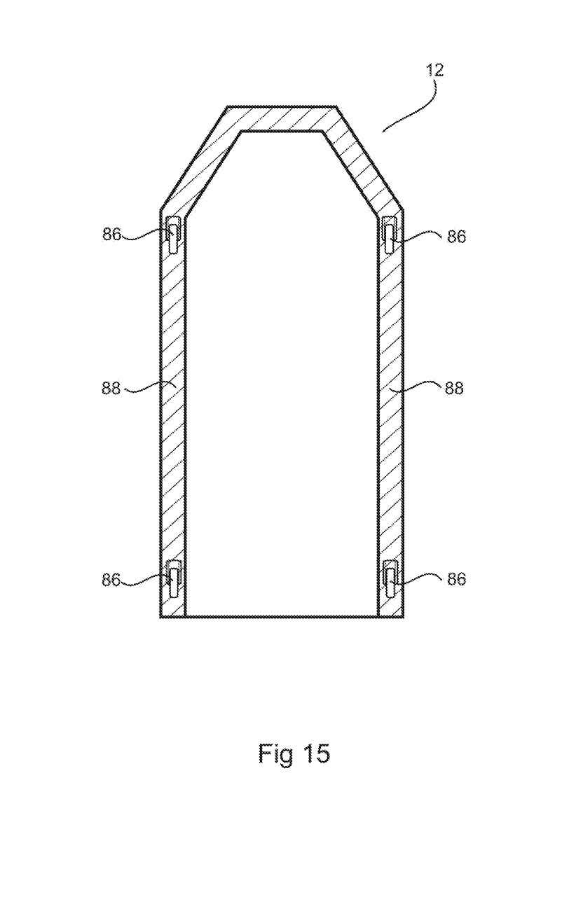

We refer now to FIGS. 14 and 15.

FIGS. 14 and 15 show a particular arrangement of the storage unit 10 in accordance with the second embodiment of the embodiment of the invention. This particular arrangement comprises a plurality of swivel casters 86. The casters 86 are attached to the frame 88 onto which the canopy 90 is mounted on. This is best seen in FIG. 15.

The cover 12 depicted in FIGS. 14 and 15 is particularly useful because it facilitates moving the cover 12 from one location to another location by pushing or pulling the cover 12. Modifications and variations as would be apparent to a skilled addressee are deemed to be within the scope of the present invention.

It should be appreciated that the scope of the invention is not limited to the scope of the embodiments disclosed. By way of example, the present embodiments refer to storage areas 10 adapted to receive a single motorbike. However, other embodiments may be adapted for receiving a plurality of motorbikes or any other good or goods.

Further, it was mentioned that in accordance with the present embodiment of the invention the storage unit 10 is adapted to increase its volume to facilitate storing of the good(s) within the storage unit 10 as well as provide access to the interior of the storage unit 10 through the periphery of the storage unit 10. In these particular embodiments this was accomplished by tilting the cover 12. However, the scope of the invention is not limited to these particular arrangements. Other embodiments may include arrangements of storage units 10 having side walls 30 which are adapted to provide access to the interior of the storage unit 10 through the sides of the storage unit 10. Also, the cover 12 may be adapted for increasing the inner volume provided by the storage unit 10.

Moreover, in accordance with the present embodiments of the invention, the lower portion of the front wall 26 cover 12 is pivotally attached to the front 40 of the trailer 16. In other arrangements, the front wall 26 may be configured such that the lower portion of the front wall 26 is pivotally attached to the front of the trailer 16 via a single pivotal joint. For example, the front 26 may be configured as a pointed tip wherein the lower portion of the pointed tip may be pivotally attached to the front 40 of the trailer 16 defining the single pivotal joint. This arrangement is particularly useful because it provides access to the interior of the storage area 10 through the sides as well as through the front of the unit 10 of the storage area 10 when the cover 12 is in the tilted condition. Thus, this particular arrangement provides access to the interior of the storage through the entire periphery of the storage area.

Throughout this specification, unless the context requires otherwise, the word “comprise” or variations such as “comprises” or “comprising”, will be understood to imply the inclusion of a stated integer or group of integers but not the exclusion of any other integer or group of integers.

1-32. (canceled)

33. A storage unit comprising a cover adapted to be mounted on a support surface, the cover comprising a front end pivotally attached to the support surface to allow selective displacement of the cover between a tilted condition and an un-tilted condition, a top, two sides and a rear open end, each side having an upper end for attachment to the top and a lower end adapted for abutment to the support surface when the cover is in the un-tilted condition and spaced apart from the support surface when the cover is in the tilted condition, the top comprising a top rear edge and each side comprising a side rear edge, wherein the rear open end is bounded by the top and side rear edges

34. A storage unit according to claim 1, wherein the cover comprises at least one door, the door being configured for selectively opening and closing the rear end.

35. A storage unit according to claim 1, further comprising the support surface.

36. A storage unit according to claim 3, wherein the support surface comprises a trailer having an upper surface for receiving the cover and a lower surface comprising a plurality of wheels to allow movement of the trailer.

37. A storage unit according claim 2, wherein the door is pivotally attached to a rear location of the support surface to allow selective displacement of the door between an open condition and a closed condition.

38. A storage unit according to claim 5, wherein the door is configured to define a ramp extending downwards from the rear location of the support surface when the door is in the open condition.

39. A storage unit according to claim 2, wherein the door is pivotally attached to one of the rear side edges of the cover for selectively closing and opening of the rear end.

40. A storage unit according to claim 2, wherein there are a pair of doors, one door is pivotally attached to the one rear side edge of the cover and the other door is pivotally attached to the other rear side edge of the cover to allow selectively closing and opening of the rear end.

41. A storage unit according to claim 1, wherein the cover is adapted to be moved.

42. A storage unit according to claim 9, wherein the cover comprises a plurality of swivel castors attached to the lower end of the sides of the covers.

43. A storage unit according to claim 1, wherein the cover further comprises a support frame adapted to be mounted on the support surface, the support frame being adapted for pivotally receiving the front end of the cover and for receiving the lower ends of the sides of the cover.

44. A storage unit according claim 1, wherein the storage unit comprises at least one gas strut having an end attached to the support surface and another other end attached to the cover.

45. A storage unit according to claim 12, wherein the gas strut is adapted to secure the cover at any location within a range of movement between the tilted condition and the un-tilted condition.

46. A storage unit according to claim 1, wherein the storage unit comprises means for fastening at least one good within the storage unit.

47. A storage unit according to claim 14, wherein the at least one good comprises at least one motorbike.

48. A cover for mounting on a support surface, the cover comprising a front end adapted to be pivotally attached to the support surface to allow selective displacement of the cover between a tilted condition and an un-tilted condition, a top, two sides and a rear end, each side having an upper end for attachment to the top and a lower end adapted for abutment to the support surface when the cover is in the un-tilted condition and spaced apart from the support surface when the cover is in the tilted condition, the top comprising a top rear edge and each side comprising a side rear edge, wherein the rear open end is bounded by the top and side rear edges.

49. A cover according to claim 16, wherein the cover comprises a front portion and a rear portion attached to the front portion, the rear portion comprising the top, two first side walls and a plurality of first slanted roofs joining the first side walls to the top of the cover, and wherein the front portion comprises two second side walls, a front wall and a plurality of second slanted roofs joined together defining a truncated slanted front end, the front wall being pivotally attached to the support surface.

50. A cover according to claim 17, wherein the cover comprises a plurality of swivel castors attached to the lower end of the sides of the covers.

51. A cover according to claim 16, wherein the cover further comprises a support frame adapted to be mounted on the support surface, the support frame being adapted for pivotally receiving the front end of the cover and for receiving the lower ends of the sides of the cover.

52. A cover according to claim 16, further comprising means for storing articles within the cover and/or solar panels for charging batteries and providing electricity to illumination means.
